(19) United States
(12) Patent Application Publication
(10) Pub. No.: US 2009/0048002 A1
(43) Pub. Date: Feb. 19, 2009

(54) PORTABLE TERMINAL

(75) Inventor: Mika Torii, Shizuoka (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 12/067,019

(22) PCT Filed: Sep. 8, 2006
(86) PCT No.: PCT/JP2006/317911

§ 371 Date: Mar. 14, 2008

(30) Foreign Application Priority Data
Sep. 14, 2005 (JP) 2005-267191

(51) Int. Cl. H04M 1/00

(52) U.S. Cl. 455/566

(57) ABSTRACT

A portable terminal capable of obtaining an input device having an intuitive and delicate instantaneous responsibility is provided by performing a manipulation of a second housing while viewing a display unit of a first housing.

This portable terminal 10 includes a first housing 11 where a display 14 is provided; and a second housing 12 where a control unit 16 is provided. The second housing 12 is coupled to the first housing 11 in a freely pivotally rotatable manner along two directions perpendicular to each other around a first coupling shaft 18 and a second coupling shaft 19, which are two shafts intersected perpendicular to each other. In the portable terminal, the first housing 11 is griped by, for example, a left hand, and also the second housing 12 is griped by, for instance, a right hand corresponding to one's dominant hand. Since the second housing 12 is manipulated along a direction perpendicular to the first housing 11, an operation of an application program within the display is controlled while the display of the first housing 11 is viewed.

### TECHNICAL FIELD

The present invention is related to a portable terminal having a plurality of housings, and capable of executing application programs such as games.

### BACKGROUND ART

Conventionally, portable terminals such as portable telephones have equipped with display units and operation units provided on housings. In such portable terminals, when telephone calls are sent and/or received, and also, electronic mails are formed, users depress/manipulate respective keys of the operation units by using their finger tips so as to enter characters and convert entered characters into kanji characters (Chinese characters), and the like.

Currently, portable terminals capable of executing application programs such as games have been proposed.

In such portable terminals, for instance, in order that characters of games being displayed on display units are moved along an upper direction, a lower direction, a right direction, and a left direction and also, these characters are caused to perform specific operations, there are many possibilities that keys to which predetermined functions have been allocated are depressed/manipulated as input devices.

Generally speaking, with respect to input devices which are employed in application programs such as games, delicate operability is required.

However, since keys of operation units of the conventional portable terminals have been used as the input devices for the games, there is such a problem that such delicate operability can not be realized.

More specifically, in recent portable terminals, surface areas of respective keys and depression strokes thereof are being decreased in connection with slim and compact requirements for housings of these portable terminals. As a result, delicate operability required for application programs such as games can be furthermore hardly secured.

To solve such a problem, a portable terminal in which antenna manipulations with respect to a housing thereof are utilized as input devices has been proposed.

In the above-described portable terminal, since the antenna is moved along an axial direction and is axially rotated with respect to the housing, for example, when characters are entered, these characters are selected and so on (refer to, for instance, Patent Publication 1).

### Patent Publication 1: JP-A-2001-52567 (FIG. 5)

### DISCLOSURE OF THE INVENTION

### Problems that the Invention is to Solve

However, in the Patent Publication 1, since the motion modes of the antenna functioning as the input device constitute the manipulations which are slightly different from the movement of the character on the display unit, there is such a problem that the motion modes of the antenna have poor intuitive operability.

Also, recently, such portable terminals in which antennas have been built-in will become major portable terminals, so that the antennas cannot be employed as the input devices. Accordingly, substitutive resolution ideas are required.

The present invention is made to solve the above-described problems, and therefore, has an object to provide a portable terminal capable of realizing an input device which has intuitive as well as delicate operability.

### Means for Solving the Problems

To achieve the above-described object, a portable terminal according to the present invention includes: a first housing and a second housing; a coupling portion provided in order to couple the first housing to the second housing, and also to guide both the first housing and the second housing from a first condition under which the first housing and the second housing are stacked with each other up to a second condition under which the first housing and the second housing are relatively moved along a separation direction; a display unit provided on the first housing; a control unit which displays an image on the display unit, the image being interlinked to an application program; and a detecting section which detects a relative position between the first housing and the second housing as a detection value, wherein the control unit controls the application program based upon the detection value of the detecting section.

In such a portable terminal, for example, while the second housing is griped by a dominant hand of a user and the first housing is griped by the other hand of the user, if a relative position of the second housing is adjusted with respect to the first housing by the dominant hand, then the relative position between the first housing and the second housing is detected by the detecting section, and the control unit controls the application program based upon this detection value.

As a consequence, since the user can easily manipulate the portable terminal while viewing an image displayed on the display unit, intuitive and delicate operability can be obtained, as compared with those of the conventional portable terminal.

Furthermore, the portable terminal according to the present invention is characterized by that the detection value of the detecting section is three-value or larger.

In this case, such a case that the detection value is three-value or larger indicates that the detection value is three-value or larger and is N-value or smaller (symbol “N” is natural number larger than, or equal to 3, and may become infinite). Moreover, when symbol “N” becomes infinite, such a case that the detection value is three-value or larger indicates such a fact that the detection value corresponds to such a value which is continuously changed.

In such a portable terminal, since the detection value of the detecting section is three-value or larger, the relative position between the first housing and the second housing can be precisely detected.

Also, the portable terminal according to the present invention, is characterized in that the coupling portion includes: a first coupling shaft which is provided in any one of the first housing and the second housing along a stacking layer direction of both the first housing and the second housing; and a second coupling shaft which is provided in the other of the first housing and the second housing and is orthogonally coupled to the first coupling shaft, and wherein the detecting section includes: a first angle detecting unit which detects a first relative angle between the first housing and the second housing centering on the first coupling shaft; and a second angle detecting unit for detecting a second relative angle between the first housing and the second housing centering on the second coupling shaft.

In such a portable terminal, the relative angle between the first housing and the second housing is detected by the first angle detecting unit centering on the first coupling shaft, and also, the relative angle between the first housing and the second housing is detected by the second angle detecting unit centering on the second coupling shaft. As a result, the relative position between the first housing and the second housing can be detected in a three-dimensional manner.

As a consequence, in this portable terminal, the second housing can be swung along the front, rear, right, and left directions with respect to the fixed first housing, so that more intuitive and delicate operability can be obtained.

In addition, the portable terminal according to the present invention is characterized in that the coupling portion includes: a rail provided on any one of a rear face of the first housing and a front face of the second housing; and an engaging portion provided on the other of the rear face of the first housing and the front face of the second housing, for being engaged with the rail; and wherein the detecting section includes a position detecting unit which detects a relative position between the rail and the engaging portion.

In such a portable terminal, the first housing and the second housing can be reciprocated in a linear mode in such a manner that the first housing is approached to, and is separated from the second housing. As a result, a suitable operability for a specific application program can be achieved.

Furthermore, a portable terminal according to the present invention includes a first housing on which a display unit is provided; a second housing arranged adjacent to the first housing; a coupling shaft orthogonally arranged with respect to a boundary face between the first housing and the second housing, for coupling the first housing to the second housing with each other in a pivotally rotatable manner; a plurality of operation units provided on different outer planes of the second housing, respectively; a control unit which displays an image on the display unit, the image being interlinked to an application program; a detecting section which detects a relative angle between the first housing and the second housing as a detection value centering on the coupling shaft; and wherein any of the plural operation units can be selectively arranged on the same side as the displaying unit by relatively rotating the first housing and the second housing centering on the coupling shaft; and wherein the control unit controls the application program based upon the detection value of the detecting section.

In such a portable terminal, since the first housing and the second housing can be manipulated in a twist manner, a suitable operability for a specific application program can be achieved.

In addition, in the portable terminal, the first housing is coupled to the second housing by employing a single coupling shaft in such a manner that the first housing can be pivotally and relatively rotated with respect to the second housing. As a result, the intuitive and delicate instantaneous responsibility can be achieved with a simple structure.

### ADVANTAGE OF THE INVENTION

In accordance with the portable terminal of the present invention, since such a manipulation for adjusting the relative position of the second housing with respect to the first housing is employed, the portable terminal can be manipulated while viewing the image. As a result, the intuitive and delicate instantaneous responsibility can be achieved with a simple structure.

### BRIEF DESCRIPTION OF THE DRAWINGS

FIG. 1 is a perspective view for showing a portable terminal according to a first embodiment of the present invention.

FIG. 2 is a front view for indicating the portable terminal according to the first embodiment.

FIG. 3 is a side view for indicating the portable terminal according to the first embodiment.

FIG. 4 is a front view for explaining control operations for searching characters in the portable terminal according to the first embodiment.

FIG. 5 is a side view for explaining control operations for searching characters in the portable terminal according to the first embodiment.

FIG. 6 is a front view for describing control operations for drawing images in the portable terminal according to the first embodiment.

FIG. 7 is a front view for showing a portable terminal according to a second embodiment of the present invention.

FIG. 8 is a perspective view for showing a portable terminal according to a third embodiment of the present invention.

FIG. 9 is a front view for showing the portable terminal according to the third embodiment.

FIG. 10 is a side view for showing the portable terminal according to the third embodiment.

FIG. 11 is a perspective view for showing a portable terminal according to a fourth embodiment of the present invention.

FIG. 12 is a perspective view for explaining a manipulation example as to a portable terminal according to a fifth embodiment of the present invention.

### DESCRIPTION OF REFERENCE NUMERALS AND SIGNS

10, 50, 60, 70, 80 portable terminal
11 first housing
12 second housing
13, 81 coupling portion
14 display (display unit)
15 function key
16, 51, 61, 75 control unit
17 decision key
18 first coupling shaft
19 second coupling shaft
20, 83 detecting section
21 first angle detecting unit
22 second angle detecting unit
71 guide rail
72 engaging portion
82 coupling shaft
84 angle detecting unit

### BEST MODE FOR CARRYING OUT THE INVENTION

Embodiments of the present invention will now be described in detail with reference to drawings.

### First Embodiment

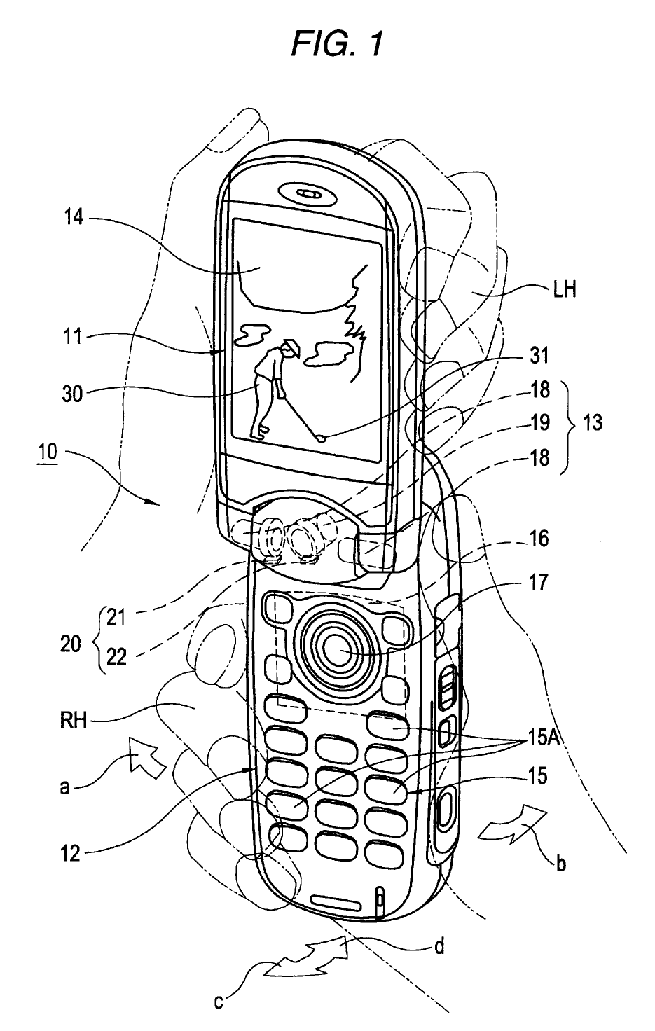

As indicated in FIG. 1, a portable terminal 10 of a first embodiment is constructed as a two-folded type portable terminal capable of selecting a first condition and a second condition by pivotally rotating a first housing 11 and a second housing 12 via a coupling portion 13 in a relative manner.

Both the first housing 11 and the second housing 12 are made in substantially rectangular shapes respectively, as viewed in a face, and also are formed in substantially same shapes.

In this case, the first condition implies such a condition that the first housing 11 and the second housing 12 are mutually stacked on each other.

A display 14 functioning as a display unit is provided on a surface of the first housing 11. Also, a function key group 15 is provided on a surface of the second housing 12, and a control unit 16 is provided inside the second housing 12.

The function key group 15 contains various sorts of keys 15A for controlling the control unit 16. A decision key 17 for determining a selected function (for example, character and the like) is provided in the function key group 15.

The control unit 16 causes the display 14 to display thereon an image which is interlinked with an application program.

The coupling portion 13 is constituted by one pair of first coupling shafts 18 and also a second coupling shaft 19.

One pair of the first coupling shafts 18 are provided by being separated from each other in a predetermined interval on a coaxial line under such a condition that the first coupling shafts 18 are located along such a direction intersected with respect to the stacking direction of the first housing 11 and the second housing 12.

The first coupling shafts 18 are provided on the second housing 12, and correspond to such supporting shafts which support the first housing 11 with respect to the second housing 12 in a freely swingable manner.

Since the first housing 11 and the second housing 12 are pivotally rotated in the relative manner while the first coupling shafts 18 are set to a center, the portable terminal 10 can be folded from the second condition to the first condition, and also, can be expanded from the first condition to the second condition.

The second coupling shaft 19 is provided between one pair of the first coupling shafts 18. This second coupling shaft 19 is provided under such a condition that the second coupling shaft 19 is orthogonally arranged with respect to the first coupling shafts 18.

The second coupling shaft 19 is provided on the first housing 11 as one example, and corresponds to such a supporting shaft which supports the second housing 12 with respect to the first housing 11 in a freely swingable manner.

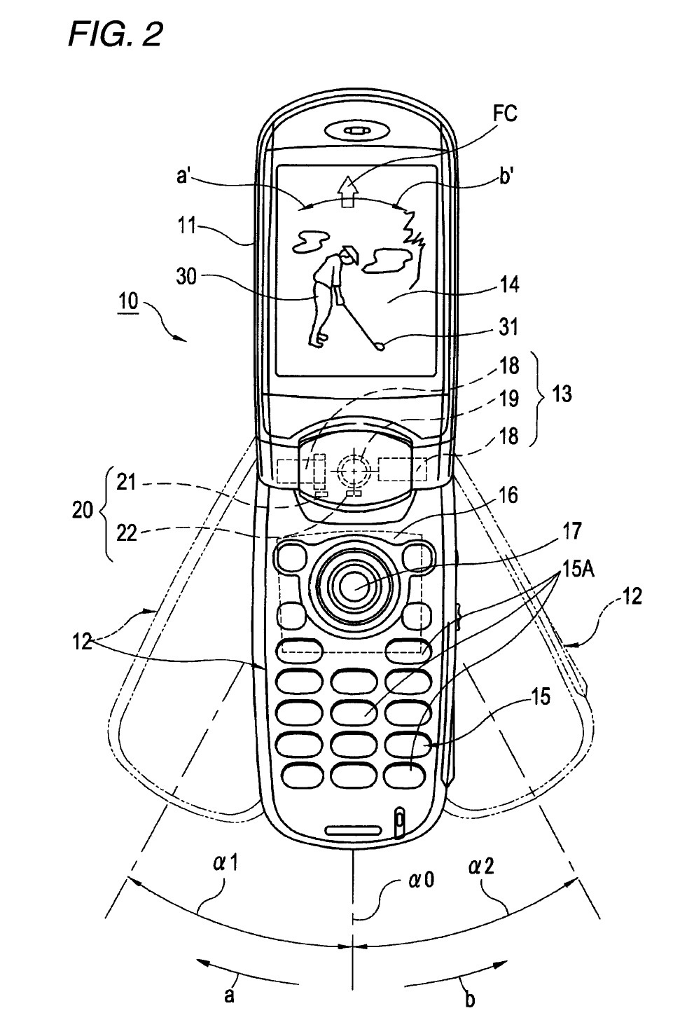

As shown in FIG. 2, in the first and second housing 11 and 12 under the second condition, the second housing 12 can be pivotally rotated (swung) along right and left directions as indicated by arrows “a” and “b”, while the second coupling shaft 19 is set to a center.

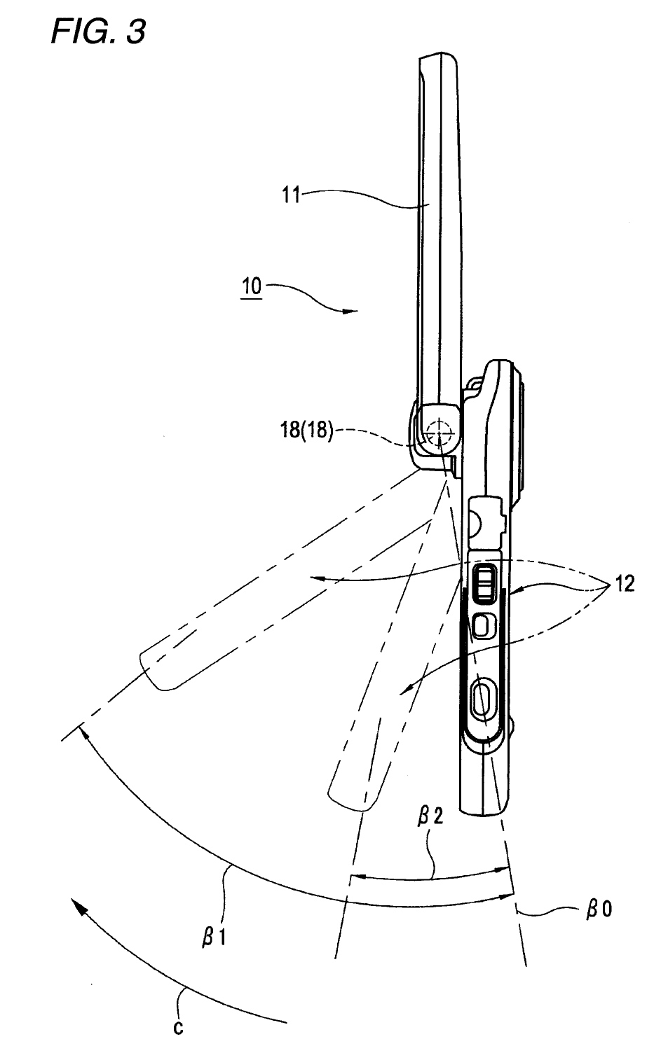

As shown in FIG. 3, in the first and second housing 11 and 12 under the second condition, the second housing 12 can be pivotally rotated (swung) along front and rear directions as indicated by arrows “c” and “d”, while the first coupling shafts 18 are set to a center.

Returning back to FIG. 1, the portable terminal 10 includes a mode selecting section (not shown) capable of selecting a key input mode and a housing input mode, and also, includes a detecting section 20 capable of detecting relative positions of the first housing 11 and the second housing 12. The detecting section 20 contains a first angle detecting unit 21 and a second angle detecting unit 22.

It should be noted that the portable terminal 10 is selected to the housing input mode.

As one example, the first angle detecting unit 21 contains a rotary encoder mounted on the second housing 12. This first angle detecting unit 21 detects relative angles as to the first housing 11 and the second housing 12 when the first and second housings 11 and 12 are relatively swung while the first coupling shafts 18 are set to a center.

As one example, the second angle detecting unit 22 contains a rotary encoder mounted on the first housing 11. This second angle detecting unit 22 detects relative angles as to the first housing 11 and the second housing 12 when the first and second housings 11 and 12 are relatively swung while the second coupling shaft 19 is set to a center.

Specifically, as shown in FIG. 3, when the second housing 12 is pivotally rotated from a reference point “β0” to the arrow “c” direction (namely, direction directed to user), while the first coupling shafts 12 are set to the center, the first detecting unit 21 detects a pivotal rotation angle “β1”, and another pivotal rotation angle “β2.”

In other words, the rotation angles β1 and β2 are determined based upon such positions, namely, while the first coupling shafts 18 are set to the center, the second housing 12 is pivotally rotated from the reference point “β0” to the arrow “c” direction and then the second housing 12 is stopped for a time period longer than, or equal to a predetermined time, or the pivotal rotation speed becomes smaller than, or equal to a predetermined pivotal rotation speed.

As a consequence, in the case that the user pivotally rotates the second housing 12 at a small angle, the pivotal rotation angle β2 is detected, whereas in the case that the user pivotally rotates the second housing 12 at a large angle, the pivotal rotation angle β1 is detected.

Also, as shown in FIG. 2, when the second housing 12 is pivotally rotated from a reference point “α0” to the arrow “a” direction while the second coupling shaft 19 is set to a center, the second angle detecting unit 22 detects a pivotal rotation angle “α1” of the second housing 12.

Similarly, when the second housing 12 is pivotally rotated from the reference point “α0” to the arrow “b” direction while the second coupling shaft 19 is set to the center, the second angle detecting unit 22 detects a pivotal rotation angle “α2” of the second housing 12.

Based upon the angle data (detected values) detected by the first angle detecting unit 21 and the second angle detecting unit 22, the control unit 16 controls an application program.

It should also be understood that as to the first angle detecting unit 21 and the second angle detecting unit 22, the respective detected values thereof are three-value or larger and N-value or smaller.

In this case, if symbol “N” is such a natural number larger than, or equal to 3 and is equal to an infinity, then the first angle detecting unit 21 and the second angle detecting unit 22 detect angle data by continuously changing values, and thus, can detect correct angle data.

Next, a description is made of such an example that a golf game is performed by using the portable terminal 10 with reference to FIG. 1 through FIG. 3.

Firstly, as shown in FIG. 1, the first housing 11 is griped by a hand (left hand, as one example) “LH” of a user, which is a non-dominant hand of the user, and the second housing 12 is griped by a right hand “RH” which is a dominant hand of the user.

Under this condition, as represented in FIG. 2, the user swings the second housing 12 along the arrow “a” direction and the arrow “b” direction while the second coupling shaft 19 is set to the center. The pivotal rotation angles “α1” and “α2” of the second housing 12 are detected by the second angle detecting unit 22, and then, the detected angle data are transferred to the control unit 16. The control unit 16 controls an application program based upon the transferred angle data.

As a consequence, a driving direction “FC” of a golf ball 31 which is tried to be driven by a golf player 30 indicated on the display 14 can be freely controlled while viewing the display 14.

Specifically, the driving direction FC of the ball can be freely controlled at arbitrary angles along an arrow “a′” direction and another arrow “b′” direction within the display 14.

In other words, an angle of the driving direction FC of the ball 31 is adjusted in response to the magnitudes of the pivotal rotation angles 21 and 22.

After the control for the driving direction FC of the ball has been accomplished, the user depresses the decision key 17 so as to determine the driving direction FC of the ball 31 which is tried to be driven by the player 30.

Next, as shown in FIG. 3, while the first coupling shafts 18 are set to the center, the second housing 12 is pivotally rotated to the arrow “c” direction and the arrow “d” direction. The pivotal rotation angles “β1” and “β2” of the second housing 12 are detected by the first angle detecting unit 21, and then, the detected angle data are transferred to the control unit 16. The control unit 16 controls the application program based upon the transferred angle data.

As a consequence, hitting force exerted when the player 30 hits the ball 31 can be freely controlled while the user views the display 14.

In this case, in addition to the pivotal rotation angles “β1” and “β2”, a pivotal rotation speed (angular velocity) is detected by pivotally rotating the second housing 12 being griped by the right hand RH from the reference point “β0” up to the pivotal rotation angles “β1” and “β2” in a fast speed, or in a slow speed.

The above-described detection data are transferred to the control unit 16 and then, the control unit 16 controls the application program based upon the transferred angle data and speed data.

As a result, the hitting force of the ball when the player hits this ball can be freely controlled in a variable manner.

It should also be noted that since any one, or both of the pivotal rotation speeds and the pivotal rotation distances (pivotal rotation angles) of the second housing 12 along the arrow “c” direction and the arrow “d” direction are controlled, the hitting force of the ball 31 can be freely controlled.

As a consequence, both the method for controlling the hitting force of the ball 31 based upon controlling of the magnitudes of the pivotal rotation angles “β1” and “β2”, and also, the method for controlling the hitting force of the ball 31 based upon controlling of the pivotal rotation speed (angular velocity) of the second housing 12 can be carried out.

As previously described, since the second housing 12 is pivotally rotated along the arrow “a” direction, the arrow “b” direction, the arrow “c” direction, and the arrow “d” direction, the driving direction FC of the ball 31 and the hitting force thereof can be controlled. As a result, controlling of the driving direction FC and also the hitting force of the ball 31 can be readily and lightly carried out, while the display 14 is viewed.

As a consequence, the user can have the attendance feeling as if the user were actually playing the golf, so that intuitive and delicate instantaneous responsibility can be improved.

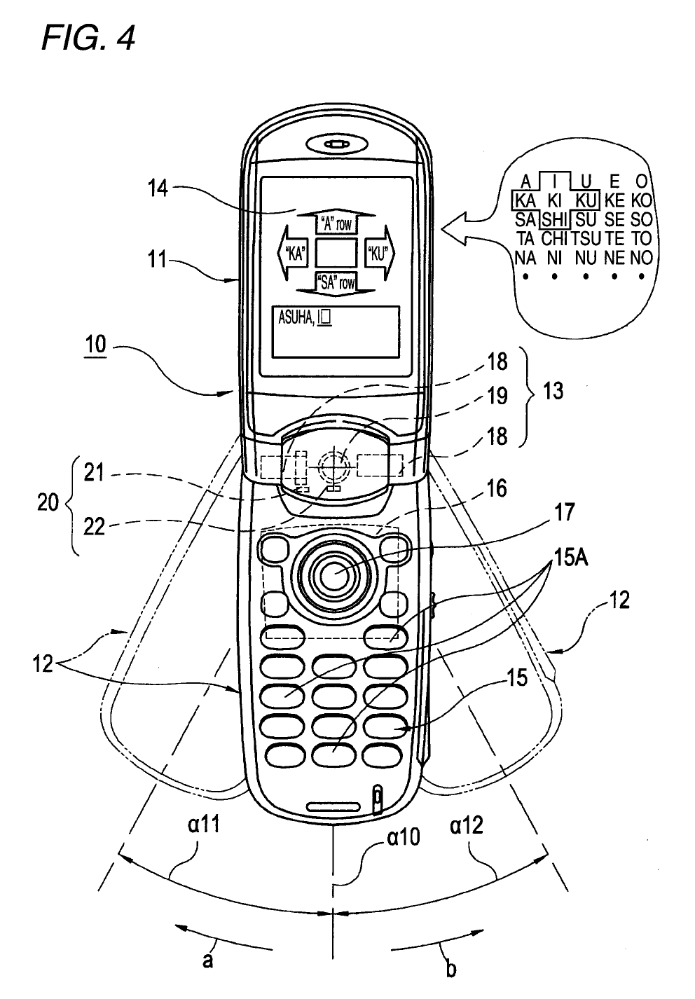

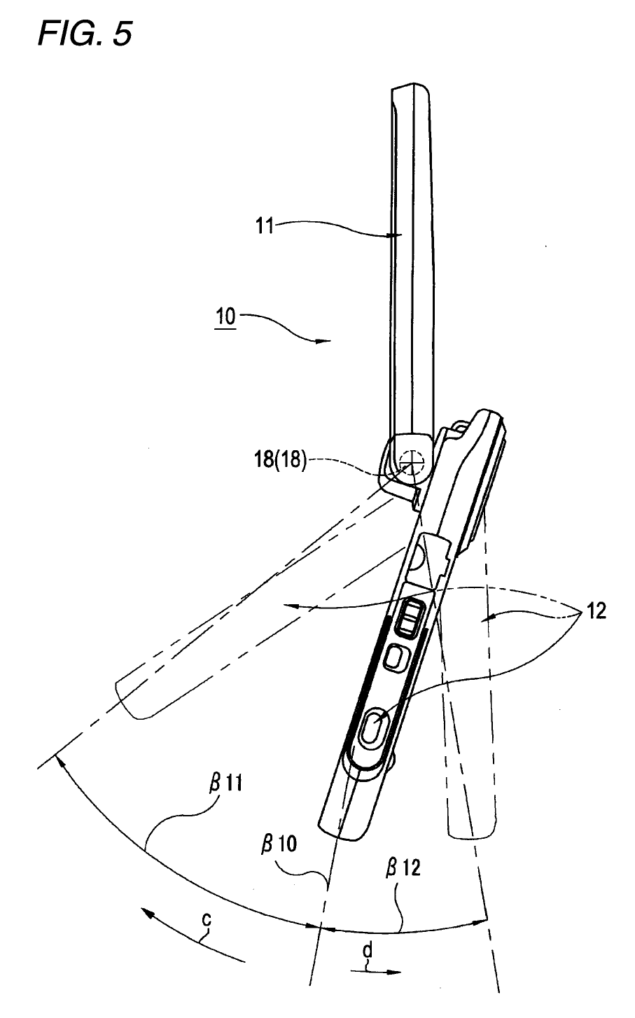

Next, a description is made of such an operation example that a character searching operation is carried out by employing the portable terminal 10 with reference to FIG. 4 and FIG. 5.

Similar to the above-described operations of the golf game, in this case, the user grips the first housing 11 by his left hand LH opposite to his dominant hand, and also grips the second housing 12 by the right hand RH corresponding to his dominant hand.

Then, as shown in FIG. 4, the user swings the second housing 12 from a reference point “α10” along the arrow “a” direction and the arrow “b” direction while the second coupling shaft 19 is set to the center. Pivotal rotation angles “α11” and “α12” of the second housing 12 are detected by the second angle detecting unit 22, and then, the detected angle data are transferred to the control unit 16. The control unit 16 controls an application program based upon the transferred angle data.

As a result, changing of the right direction and the left direction as to such a character being represented on the display 14 can be freely controlled while the user views the display 14.

Moreover, as shown in FIG. 5, the user swings the second housing 12 from a reference point “β10” along the arrow “c” direction and the arrow “d” direction while the first coupling shafts 18 are set to the center. Pivotal rotation angles “β11” and “β12” of the second housing 12 are detected by the first angle detecting unit 21, and then, the detected angle data are transferred to the control unit 16. The control unit 16 controls the application program based upon the transferred angle data.

As a result, changing of the up direction and the down direction as to such a character being represented on the display 14 can be freely controlled while the user views the display 14.

A description is made of a concrete example for entering “kana” characters.

As shown in FIG. 4, under such a condition that a display character “ki” is being displayed on the display 14, the second housing 12 is pivotally rotated from the reference point α10 along the arrow “a” direction by the pivotal rotation angle α11, and thereafter, the second housing 12 is returned to the reference point α10.

The character being displayed on the display 14 is converted from “ki” of the display character of FIG. 4 into “ka” present in the same row.

Similarly, the second housing 12 is pivotally rotated from the reference point α10 along the arrow “b” direction by the pivotal rotation angle α12, and thereafter, the second housing 12 is returned to the reference point α10.

The character being displayed on the display 14 is converted from “ki” of the display character of FIG. 4 into “ku” present in the same row.

As described above, the second housing 12 is pivotally rotated along the arrow “a” direction and the arrow “b” direction, so that the character searching operation on the same row can be carried out within the character string of the Japanese syllabary.

On the other hand, as shown in FIG. 5, the second housing 12 is pivotally rotated from the reference point β10 along the arrow “c” direction by the pivotal rotation angle β11, and thereafter, the second housing 12 is returned to the reference point β10.

The character being displayed on the display 14 is converted from “ki” of the display character of FIG. 4 into “i” present in the “a” row corresponding to such a row located above the “ka” row.

Similarly, the second housing 12 is pivotally rotated from the reference point β10 along the arrow “d” direction by the pivotal rotation angle β12, and thereafter, the second housing 12 is returned to the reference point β10.

The character being displayed on the display 14 is converted from “ki” of the display character of FIG. 4 into “shi” present in the “sa” row corresponding to such a row located under the “ka” row.

As described above, the second housing 12 is pivotally rotated along the arrow “c” direction and the arrow “d” direction, so that the character searching operation in the different rows can be carried out within the character string of the Japanese syllabary.

After the desirable key is searched, the decision key 17 is depressed, so that the searched character can be determined.

It should also be understood that the arranging method for the character string of the Japanese syllabary may be converted by 90 degrees. As a result, a character searching operation within the same row may be carried out by pivotally rotating the second housing 12 along the arrow “c” direction and the arrow “d” direction, and also a character searching operation within different rows may be carried out by pivotally rotating the second housing 12 along the arrow “a” direction and the arrow “b” direction.

As described above, since the second housing 12 is pivotally rotated along either the arrow “a” direction and the arrow “b” direction or the arrow “c” direction and the arrow “d” direction so as to perform the character changing operation, the character changing operation may be easily and lightly carried out while viewing the display 14.

As a consequence, when data is transmitted and/or received during electronic mailing operation and the Internet communicating operation, the intuitive and delicate instantaneous responsibility can be improved.

It should also be understood that the present invention is not limited only to the character searching methods of FIG. 4 and FIG. 5, but may be alternatively realized by performing the below-mentioned character searching method.

That is to say, after the second housing 12 has been pivotally rotated from the reference point “β10” up to the predetermined pivotal rotation angles “β11” or “β12”, since this condition is maintained, character strings may be sequentially changed in a continuous manner.

Then, when a desirable character string is displayed, the second housing 12 is returned to the reference point β10, and then, the decision key 17 is depressed so as to determine the character string.

After the character string has been determined, the second housing 12 is pivotally rotated form the reference point “β10” up to the predetermined pivotal rotation angles “β11” and “β12”, and thereafter this condition is maintained, so that character strings may be sequentially changed in a continuous manner.

Then, when a desirable character string is displayed, the second housing 12 is returned to the reference point β10, and then, the decision key 17 is depressed so as to determine the character string.

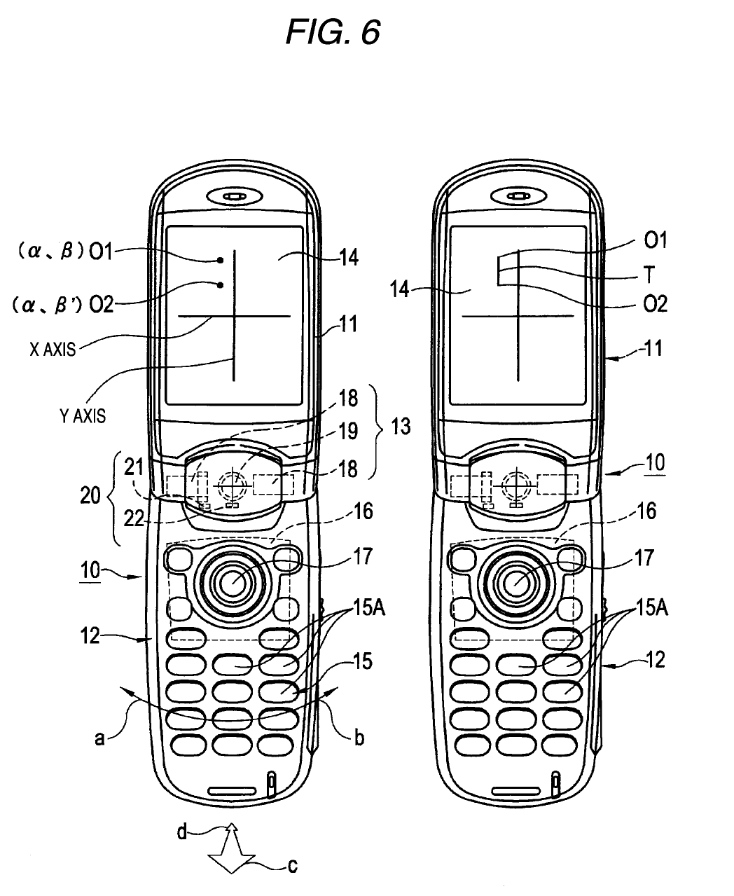

Next, a description is made of such an example that drawing software is utilized based upon (A) and (B) of FIG. 6.

Similar to the above-described operations of the golf game, in this case, the user grips the first housing 11 by his left hand LH opposite to his dominant hand, and also grips the second housing 12 by the right hand RH corresponding to his dominant hand.

Then, as shown in (A) of FIG. 6, a first origin “O1” of the drawing is indicated on the display 14. The second housing 12 is pivotally rotated along the arrow “a” direction and the arrow “b” direction while the second coupling shaft 19 is set to the center, or is pivotally rotated along the arrow “c” direction and the arrow “d” direction while the first coupling shafts 18 are set to the center.

Since the above-described pivotal rotations are carried out, the first origin “O1” of the drawing is moved to a desirable position on xy coordinates, and the decision key 17 is depressed so as to determine a coordinate position of the first origin “O1.”

Next, a second origin “O2” of the drawing is indicated. The second housing 12 is pivotally rotated along the arrow “a” direction and the arrow “b” direction while the second coupling shaft 19 is set to the center, or is pivotally rotated along the arrow “c” direction and the arrow “d” direction while the first coupling shafts 18 are set to the center.

Since the above-described pivotal rotations are carried out, the second origin “O2” of the drawing is moved to a desirable position on xy coordinates, and the decision key 17 is depressed so as to determine a coordinate position of the second origin “O2.”

Next, a line sort (straight line, arc, or other lines) for the drawing is selected by the function key group 15, and then, the decision key 17 is depressed. As a result, as represented in (B) of FIG. 6, while the center of the display 14 is defined as the origin of the xy coordinates face, a line “T” is drawn which connects the first origin O1 (α,β) to the second origin O2 (α,β′).

Since this operation is repeatedly carried out, a desirable drawing can be made.

It should also be understood that the control operation of the drawing application program is performed as follows: That is, while the center of the display 14 is defined as the origin of the xy coordinates face, 1 pixel is converted into “1”; coordinates of the first origin “O1” by input data are determined as (x direction dot number/180*α, y direction dot number/180*β), and also, coordinates of the first origin “O2” by input data are determined as (x direction dot number/180*α, y direction dot number/180*β′), so that the control operation converts the coordinates on a two-dimensional face.

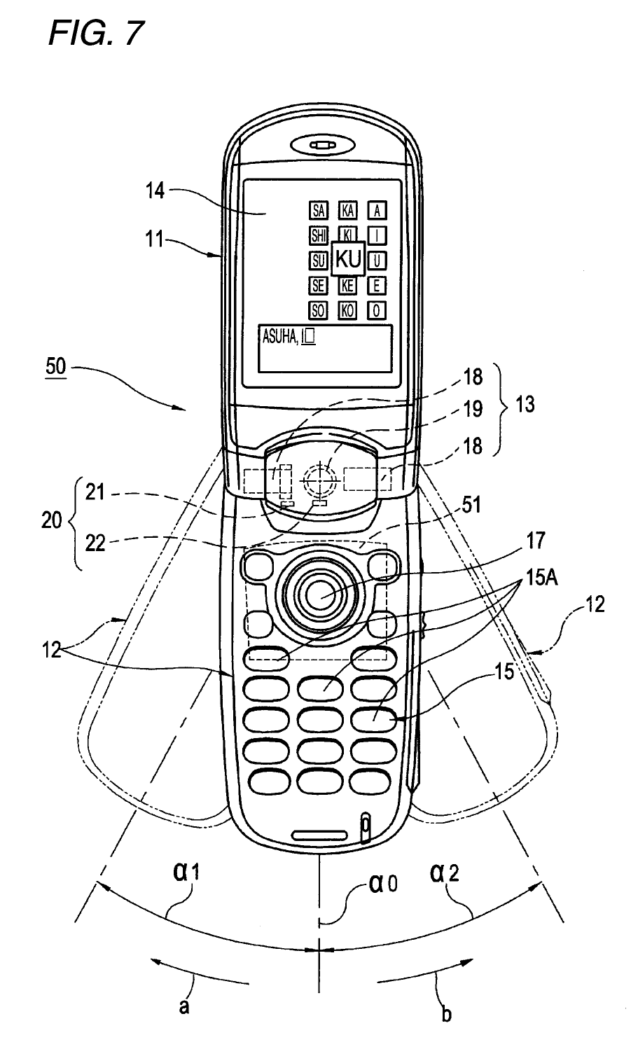

Next, a second embodiment to a fifth embodiment will now be explained based upon FIG. 7 to FIG. 12. It should be understood that the same reference numerals shown in the portable terminal 10 of the first embodiment will be employed as those for denoting the same, or similar structural members indicated in the second embodiment to the fifth embodiment, and thus, descriptions thereof will be omitted.

### Second Embodiment

A portable terminal 50 of the second embodiment shown in FIG. 7 includes a control unit 51 instead of the control unit 16 of the first embodiment, and other structural elements of the portable terminal 50 are similar to those of the portable terminal 10 corresponding to the first embodiment.

The control unit 51 includes a function for displaying a search character which is displayed on the display 14 in an enlarge mode.

A description is made of such an example that a search character to be displayed on the display 14 when characters are formed (for example, when electronic mail is written, or Internet communication is performed) is displayed in the enlarge mode.

Similar to the above-described portable terminal 10, the user grips the first housing 11 by his left hand LH opposite to his dominant hand, and also, grips the second housing 12 by his right hand RH corresponding to his dominant hand.

The second housing 12 griped by the right hand is pivotally rotated along the arrow “a” direction and the arrow “b” direction while the second coupling shaft 19 is set to a center, or is pivotally rotated along the arrow “c” direction and the arrow “d” direction while the first coupling shafts 18 are set to an axis.

With employment of this manipulation, a character searching operation when a “kana” character is entered is carried out. The search character “ku” is enlarged larger than other characters and the enlarged character “ku” is displayed.

After the character is searched, the decision key 17 is depressed so as to determine the search character.

In accordance with the portable terminal 50 of the second embodiment, since the search character is enlarged, the character searching operability can be considerably improved.

It should also be noted that in accordance with the portable terminal 50 of the second embodiment, the character searching operation may be alternatively carried out by combining the pivotal rotating operations of the second housing 12 along either the arrow “a” direction and the arrow “b” direction or the arrow “c” direction and the arrow “d” direction with a voice input or the like. As a result, all of the character searching operations may be carried out by pivotally rotating the second housing 12, and the decision of the search character may be made by using the voice instead of the decision key 17.

### Third Embodiment

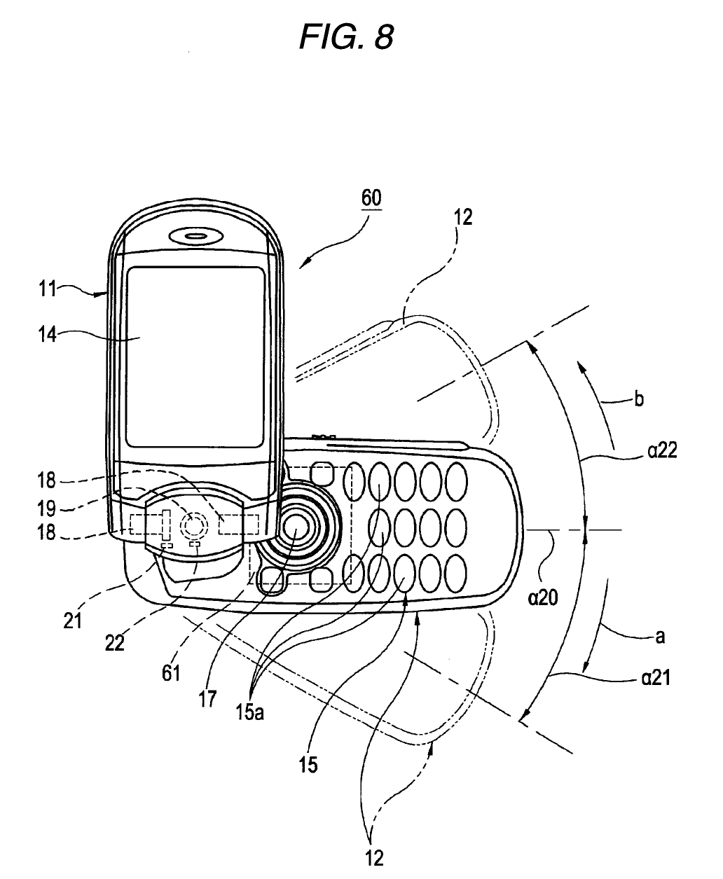

A portable terminal 60 of the third embodiment shown in FIG. 8 to FIG. 10 includes a control unit 61 instead of the control unit 16 of the first embodiment, and other structural elements of the portable terminal 60 are similar to those of the portable terminal 10 corresponding to the first embodiment.

The control unit 61 includes a function capable of performing a steering wheel manipulation and a speed control in a car race which is displayed on the display 14.

A description is made of such an example that a steering wheel manipulation and a speed control of a racing car 62 in the car race game are carried out by employing this portable terminal 60.

As shown in FIG. 8, the user grips the first housing 11 by his left hand LH opposite to his dominant hand, and also, grips the second housing 12 by the right hand RH corresponding to his dominant hand.

The second housing 12 is brought into such a condition that this second housing 12 is bent at an angle of 90 degrees along a right direction, while the second coupling shaft 19 is set to a center.

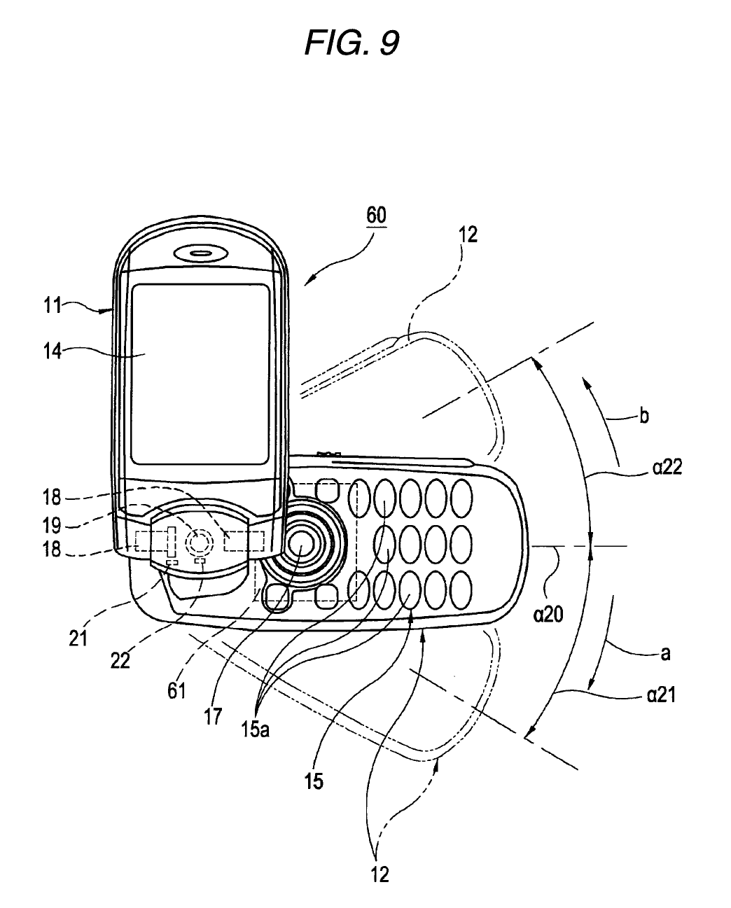

Under this condition, as represented in FIG. 9, the second housing 12 griped by the right hand RH is pivotally rotated along the arrow “a” direction and the arrow “b” direction from a reference point “α20”, while the second coupling shaft 19 is set to the center.

Pivotal rotation angles “α21” and “α22” of the second housing 12 are detected by the second angle detecting unit 22, and then, the detected angle data are transferred to the control unit 61. The control unit 61 controls an application program based upon the transferred angle data.

As a result, a traveling direction “RC” of the racing car 62 being displayed on the display 14 can be freely controlled (namely, freely steering wheel manipulation) in a variable manner by swinging the display 14 along an arrow “a′” direction and an arrow “b′” direction.

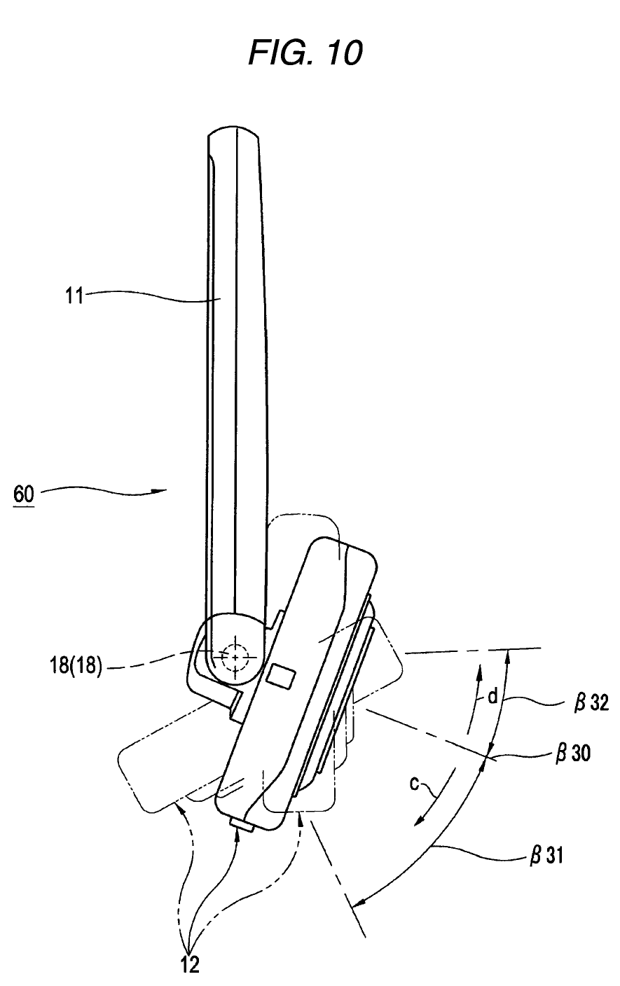

On the other hand, as shown in FIG. 10, the second housing 12 is pivotally rotated from a reference point “β30” within a pivotal rotation angle “β31” of a lower side along the arrow “c” direction while the first coupling shafts 18 are set to the center.

In this case, in addition to the pivotal rotation angle “β31”, a pivotal rotation speed (angular velocity) is detected by pivotally rotating the second housing 12 from the reference point “β30” up to the pivotal rotation angle “β31” in a fast speed, or in a slow speed.

The detected data is transferred to the control unit 16, and then, the control unit 16 controls the application program based upon the transferred angle data and/or the transferred speed data.

As a result, the speed control can be carried out in the variable manner by an acceleration work of the race car 62.

Furthermore, as shown in FIG. 10, the second housing 12 is pivotally rotated from the reference point “β30” within a pivotal rotation angle “β32” of an upper side along the arrow “d” direction while the first coupling shafts 18 are set to the center.

In this case, in addition to the pivotal rotation angle “β32”, a pivotal rotation speed (angular velocity) is detected by pivotally rotating the second housing 12 from the reference point “β30” up to the pivotal rotation angle “β32” in a fast speed, or in a slow speed.

The detected data is transferred to the control unit 16, and then, the control unit 16 controls the application program based upon the transferred angle data and/or the transferred speed data.

As a result, the speed control can be carried out in the variable manner by a braking work of the racing car 62.

As a consequence, as it were, pivotal rotation controls of the second housing 12 along the arrow “a” direction and the arrow “b” direction are substituted by the actual steering wheel manipulation of the racing car, and also, as it were, the pivotal rotation controls of the second housing 12 along the arrow “c” direction and the arrow “d” direction are substituted by the speed controls based upon the actual acceleration control and the actual braking control of the racing car.

As a result, the user can have such an attendance feeling that, as it were, the user actually performs the car race, so that intuitive and delicate instantaneous responsibility can be improved.

### Fourth Embodiment

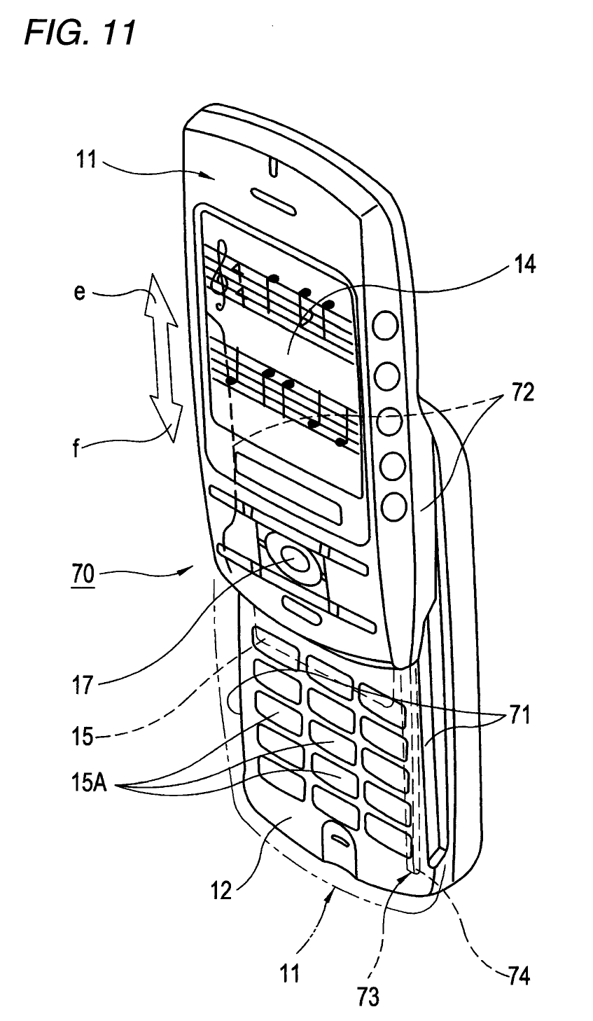

A portable terminal 70, according to the fourth embodiment, shown in FIG. 11, is arranged in such a manner that the first housing 11 is freely slid with respect to the second housing 12, and other structural elements thereof are similar to those of the portable terminal 10 corresponding to the first embodiment. In the portable terminal 70, one pair of guide rails 71 are provided on a front face of the second housing 12; one pair of engaging portions 72 are provided on a rear face of the first housing 11; and the portable terminal 70 is equipped with a detecting section 73 which detects a relative position between the guide rails 71 and the engaging portions 72, namely detects a relative position between the second housing 12 and the first housing 11.

One pair of the guide rails 71 are provided parallel to each other on both right and left sides of the front face side of the second housing 12.

One pair of the engaging portions 72 are provided parallel to each other on both right and left sides of the rear face side of the first housing 11, and are slidably engaged with one pair of the guide rails 71 respectively.

As a result, the first housing 11 is coupled on the front face of the second housing 12 in an extensible manner along an arrow “e” direction and an arrow “f” direction by the guide rails 71 and the engaging portions 72.

The detecting section 73 includes a position detecting unit 74 which detects slide amounts of the first housing 11 along the arrow “e” direction and the arrow “f” direction with respect to the second housing 12. As the position detecting unit 74, a linear encoder, or the like is contained as one example.

A description is made of such an example that software capable of playing a musical instrument such as a trombone is utilized in the above-described portable terminal 70.

Firstly, the user grips the second housing 12 by his left hand opposite to his dominant hand, and also, grips the first housing 11 by his right hand. The user slides the first housing 11 along the guide rails 10 with respect to the second housing 12 along the arrow “e” direction and the arrow “f” direction, which correspond to the upper and lower directions.

A slide amount of the first housing 11 is detected by the position detecting unit 74, and then, the detected positional data is transferred to the control unit 75. The control unit 75 controls an application program based upon the transferred angle data.

As a consequence, the user can freely adjust a musical scale and a change of key as to musical notes indicated on the display 14 in a variable manner while viewing the display 14.

In this case, the user may simultaneously select strong/weak degrees of sound, a tone quality, and the like by manipulating other buttons.

It should also be noted that the user may alternatively select the strong/weak degrees of the sound, the tone quality, and the like based upon the slide amount of the first housing 11, and at the same time, may alternatively select the musical scale and the change of key as to the musical notes indicated on the display 14 by manipulating other buttons.

As a consequence, when the musical instrument such as the trombone is played, the musical scale and the change of key as to the musical notes can be easily and lightly adjusted.

As a result, the user can play music with having attendance feeling, as it were, the user plays an actual trombone, so that intuitive and delicate instantaneous responsibility can be improved.

Furthermore, in such a case that the user plays such a game as a pin ball by employing the portable terminal 70, similar to such a case that the user utilizes the musical instrument playing software for the trombone, the user slides the first housing 11 with respect to the second housing 12 along the arrow “e” direction and the arrow “f” direction, so that the user can freely adjust strengths of hitting a ball of the pin ball game in a variable manner, and thus, can have such a feeling of jumping actions of the pin ball with the attendance feelings.

Furthermore, in such a case that the user utilizes music composing software by employing the portable terminal 70, while actual sound is secured every musical note, the user can compose music with fun by performing a similar operation when the user utilize the musical instrument playing software for the trombone.

### Fifth Embodiment

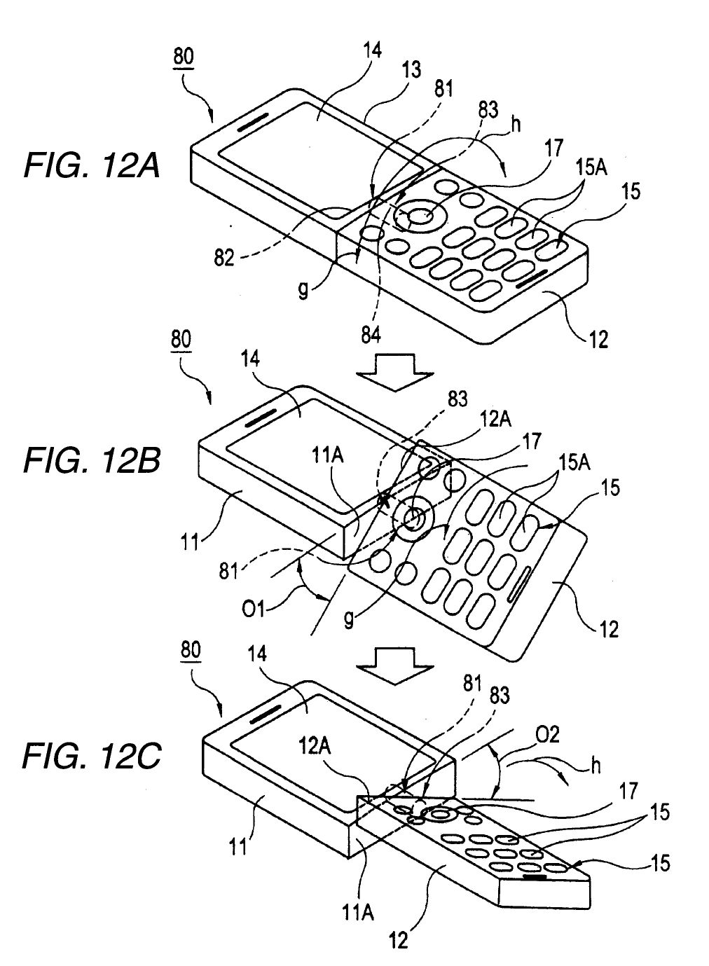

A portable terminal 80, according to the fifth embodiment of the present invention, shown in FIG. 12(A) to FIG. 12(C) is arranged as follows: That is, a first housing 11 and a second housing 12 are arranged in a series form; the portable terminal 80 includes a coupling portion 81 for coupling the first housing 11 with the second housing 12 under relatively pivotally rotatable condition; the portable terminal 80 includes a detecting section 83 capable of detecting a relative angle between the first housing 11 and the second housing 12; and other structural elements thereof are similar to those of the portable terminal 10 corresponding to the first embodiment.

The coupling portion 81 includes one piece of a coupling shaft 82 which is orthogonally arranged with respect to a boundary face 11A of the first housing 11 and a boundary face 12A of the second housing 12, and couples the first housing 11 to the second housing 12 in a mutually pivotally rotatable manner.

As one example, this coupling shaft 82 is fixed on the side of the first housing 11, and is such a member capable of being coupled to the second housing 12 along an arrow “g” direction and an arrow “h” direction in the pivotally rotatable manner.

In the detecting section 83, an angle detecting unit 84 is provided on the side of the second housing 12, and this angle detecting unit 84 is pivotally rotated with the second housing 12 in an integral manner along the arrow “g” direction and the arrow “h” direction, so that the detecting section 83 detects a pivotal rotation angle of the second housing 12 with respect to the first housing 11.

In such a case that the user plays a golf game by employing this portable terminal 80 in a similar manner to that of the above-described first embodiment, the user pivotally rotates the second housing 12 along the arrow “g” direction and the arrow “h” direction at pivotal rotation angles “θ1” and “θ2”, respectively, as represented in FIG. 12(B) and FIG. 12(C) from such a reference position where the front face of the second housing 12 is arranged to be made substantially coincident with the front face of the first housing 11 as represented in FIG. 12(A).

The respective pivotal rotation angles “θ1” and “θ2” are detected by the angle detecting unit 84, and then, the detected angle data are transferred to the control unit 16. The control unit 16 controls an application program based upon the transferred angle data.

As a consequence, similar to the portable terminal 10 of the first embodiment, the user can have such an attendant feeling that as it were, the user actually plays the golf, so that the intuitive and delicate instantaneous responsibility can be improved.

### Modification of Fifth Embodiment

As a modified example as to the portable terminal 80 of the fifth embodiment, while the coupling shaft 82 may be fixed on the side of the second housing 12, this coupling shaft 82 may be alternatively coupled to the second housing 12 in such a manner that the second housing 12 may be freely and pivotally rotated along the arrow “g” direction and the arrow “h” direction in an integral manner with respect to the coupling shaft 82.

Alternatively, the angle detecting unit 84 may be fixed on the side of the first housing 11 in order that a detection of a pivotal rotation angle of the second housing 12 with respect to the first housing 11 may be carried out due to a relative pivotal rotation effect of the coupling shaft 82 with respect to the angle detecting unit 84.

It should also be understood that the portable terminal of the present invention is not limited only to the above-described various embodiments, but may be properly modified, improved, and so on.

For instance, the first embodiment to the third embodiment have exemplified such a structure that the second housing is pivotally rotated along the two axial directions with respect to the first housing, but are not limited only to this structure. That is, alternatively, a pivotal rotation structure may be employed in which the second housing is pivotally rotated around a single coupling shaft, and another pivotal rotation structure may be employed in which the above-described single coupling shaft is pivotally rotated in an integral manner with either the second housing or the first housing along such a direction which is intersected at a right angle with a shaft center of this single coupling shaft.

In addition, materials, shapes, dimensions, modes, quantities, and arranging positions with respect to the display units, the first housings, the second housings, the boundary planes, the coupling shafts, and the respective operation units, which are exemplified in the above-described respective embodiments, may be arbitrarily selected, and may not be limited if these items may accomplish the portable terminals of the present invention.

The present patent application has been made based upon Japanese Patent Application (JP-A-2005-267191) filed on Sep. 14, 2005, the content of which is hereby incorporated by reference into this application.

### INDUSTRIAL APPLICABILITY

The present invention is suitably applied to a portable terminal having a plurality of housings, and capable of executing an application program such as a game.

1. A portable terminal, comprising:
a first housing and a second housing;
a coupling portion which couples the first housing to the second housing, and guides both the first housing and the second housing from a first condition under which the first housing and the second housing are stacked with each other up to a second condition under which the first housing and the second housing are relatively moved along a separation direction from each other;
a display unit provided on the first housing;
a control unit which displays an image on the display unit, the image being interlinked to an application program; and
a detecting section which detects a relative moving speed of the second housing with respect to the first housing,
wherein the control unit controls the application program based upon the relative moving speed detected by the detecting section.

2. A portable terminal, comprising:
a first housing and a second housing;
a coupling portion which couples the first housing to the second housing, and guides both the first housing and the second housing from a first condition under which the first housing and the second housing are stacked with each other up to a second condition under which the first housing and the second housing are relatively moved along a separation direction;
a display unit provided on the first housing;
a control unit which displays an image on the display unit, the image being interlinked to an application program; and
a detecting section which detects a relative position and a relative moving speed of the second housing with respect to the first housing,
wherein the control unit controls the application program based upon the relative moving speed detected by the detecting section.

3. The portable terminal as claimed in claim 1, wherein the coupling portion includes:
a first coupling shaft which is provided along a stacking direction of both the first housing and the second housing; and
a second coupling shaft which is orthogonally arranged with respect to the first coupling shaft; and
wherein the detecting section includes:
a first angle detecting unit which detects a first relative angle between the first housing and the second housing centering on the first coupling shaft; and
a second angle detecting unit which detects a second relative angle between the first housing and the second housing centering on the second coupling shaft.

4. The portable terminal as claimed in claim 1, wherein the coupling portion includes:
a rail provided on any one of a rear plane of the first housing and a front plane of the second housing; and
an engaging portion provided on the other of the rear plane of the first housing and the front plane of the second housing, for being engaged with the rail; and
wherein the detecting section includes a position detecting unit which detects a relative position between the rail and the engaging portion.

5. A portable terminal, comprising:
a first housing on which a display unit is provided;
a second housing arranged adjacent to the first housing;
a coupling shaft orthogonally arranged with respect to a boundary plane between the first housing and the second housing, for coupling the first housing to the second housing with each other in a pivotally rotatable manner;
a plurality of operation units provided on different outer faces of the second housing, respectively;
a control unit which displays an image on the display unit, the image being interlinked to an application program;
a detecting section which detects a rotating angle and a rotating speed of the second housing with respect to the first housing; and
wherein any of the plural operation units can be selectively arranged on the same side as the displaying unit by relatively rotating the first housing and the second housing centering on the coupling shaft; and
wherein the control unit controls the application program based upon the rotating angle and the rotating speed detected by the detecting section.
